(19) United States
(12) Patent Application Publication
(10) Pub. No.: US 2010/0222057 A1
(43) Pub. Date: Sep. 2, 2010

(54) ACCESS SYSTEM AND METHOD FOR DEVICE CONTROL

(76) Inventors: Kevin Taylor, Stoke on Trent (GB); Kevin Griffiths, Stoke on Trent (GB); Gary Aston, Stoke on Trent (GB)

Correspondence Address: HARRINGTON & SMITH, 4 RESEARCH DRIVE, Suite 202, SHELTON, CT, 06484-6212, US

(21) Appl. No.: 12/734,005

(22) PCT Filed: Oct. 6, 2008
(86) PCT No.: PCT/GB2008/003385

§ 371 Date: May 20, 2010

(30) Foreign Application Priority Data
Oct. 5, 2007 (GB) 0719524.1

(51) Int. Cl. H04W 4/00

(52) U.S. Cl. 455/435.1; 455/434

(57) ABSTRACT

An access system for device control, the system including a communications device, a registration server, a session control element and application control element contained within an access server and a subject device, the communication device arranged to provide a registration signal recognisable by the registration server as to identity and to establish a handshake control interaction, the registration server arranged to establish a register communication path to the access server, the access server having an access indicator to at least one subject device, the access server arranged to analyse the handshake control interaction to determine whether the access indicator is present in the handshake control interaction, the access server arranged to establish a session control path to an application link for the subject device, the application link establishing a device control protocol with the subject device, the system arranged whereby the registration signal and/or the handshake control interaction and/or register communication path and/or the session control path and/or the device control protocol used consistent or respectively different signal language regimes, but the handshake control interaction provides at least one control function for the subject device in terms of an allocated function control signal within the handshake control interaction.

The present invention relates to access systems and methods for controlling dispersed devices connectable to a communication network such as the World Wide Web.

It will be appreciated there is an increasing number of intelligent or semi-intelligent devices which can be controlled by appropriate feedback control mechanisms. These devices include security alarm systems, cameras, lights, visual display screens, locks, ticketing devices, media access terminals, media trial facilities, public information screens such as traffic indicator devices, toll and polling devices and other control/indicator devices such as in relation to heating control etc. Generally, each one of these devices can be locally controlled through a bespoke control device or direct action upon a keypad or potentially through a central control regime. In either case a bespoke communication path is provided to the device which will either use a bespoke dedicated signal communication protocol or a generic signal protocol with appropriate encryption. Such regimes limit wide scale application and use of access systems and methods for controlling dispersed devices.

Aspects of the present invention provide an access system for device control, the system comprising a communications device, a registration server, a session control element and application control element contained within an access server and a subject device, the communication device arranged to provide a registration signal recognisable by the registration server as to identity and to establish a hand-shake control interaction, the registration server arranged to establish a register communication path to the access server, the access server having an access indicator to at least one subject device, the access server arranged to analyse the handshake control interaction to determine whether the access indictor is present in the handshake control interaction, the access server arranged to establish a session control path to an application link for the subject device, the application link establishing a device control protocol with the subject device, the system arranged whereby the registration signal and/or the handshake control interaction and/or register communication path and/or the session control path and/or the device control protocol used consistent or respectively different signal language regimes, but the handshake control interaction provides at least one control function for the subject device in terms of an allocated function control signal within the handshake control interaction.

Also in accordance with aspects of the present invention there is provided a method for device control in an access system, the method comprising using a communication device to provide a register signal recognisable by a registration server as to identity and to establish a handshake control interaction, establishing a register communication path to an access server, arranging the access server to provide an access indicator for at least one subject device, arranging for the access server to analyse the handshake control interaction to determine whether the access indicator is present in the handshake control interaction, establishing a session control path to an application link for the subject device, the application link establishing a device control protocol with the subject device, the method arranged whereby the registration signal and the handshake control interaction and/or the registration path and/or the session control path and/or the device control protocol used consistent or respectively different signal language regimes, but the handshake control interaction provides at least one control function for the subject device in terms of an allocated function control signal within the handshake control interaction.

Typically, the communication device is a mobile communication apparatus. Typically, the mobile communication apparatus is a mobile phone, custom device or embedded controller which has connectivity to a voice network either via physical copper connection, cellular network or satellite.

Generally, the subject device comprises a security alarm or camera or light or vehicle control such as an immobiliser or television or visual display or audio distribution device or public information display or lock or access control module to services or goods.

Typically, at least the handshake control interaction is a multi-frequency tone signal language regime. Typically, the multi-frequency tone signal language regime is dual tone, multi-frequency (DTMF) signal language. Typically, each dual tone signal comprises an allocated function control signal. Typically, each dual tone signal is accessed by a key on the communication device.

Possibly, at least the handshake control interaction is a short range digital encryption signal language. Possibly, the short range digital encryption language is Blue Tooth with a respective encrypted identifier as the allocated function control signal for a respective control function for the subject device.

Possibly, the communication device incorporates a display. Possibly, the communication device receives a response from the subject device indicative of status. Possibly, the communication device, through the display, provides an indication for necessary actions to affect the allocated function control signal. Typically, the indication comprises a visual symbol indicating which key upon the control device is required to provide the allocated function control signal.

Possibly, the access server has a store for a plurality of access indicators for respective subject devices in a plurality of subject devices.

Possibly, the access server includes a user registration list, comprising previously controlled subject devices controlled by the communication device. Possibly, the access server offers the user registration list to the communication device when the registration server receives the registration signal and provides the user registration list as a signal to the communication device.

Possibly, the registration signal includes a geographic identity signal such as but not limited to global positioning system (GPS), location based services (LBS) or satellite radio navigation (Galileo) if needed to determine proximity of accessible subject devices. Possibly, the registration signal allows a geographic identification signal to be generated. Typically, the geographic identity signal is provided to the access server and the access server has a geographic subject device list, the access server can compare the geographic identity signal with the geographic subject device list and provide the geographic subject device list associated with the geographic identifier signal to the communication device.

Typically, the registration signal and/or the handshake control interaction and/or the register communication path and/or the session control path and/or the device control protocol utilise the World Wide Web.

An embodiment of aspects of the present invention will now be described by way of example and with reference to the accompanying drawing in which:

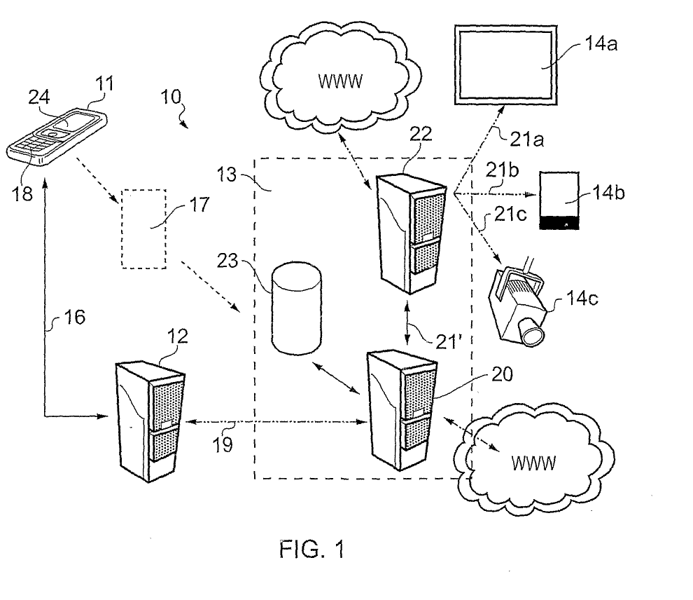

FIG. 1 provides a schematic illustration of an access system for device control in accordance with aspects of the present invention, and

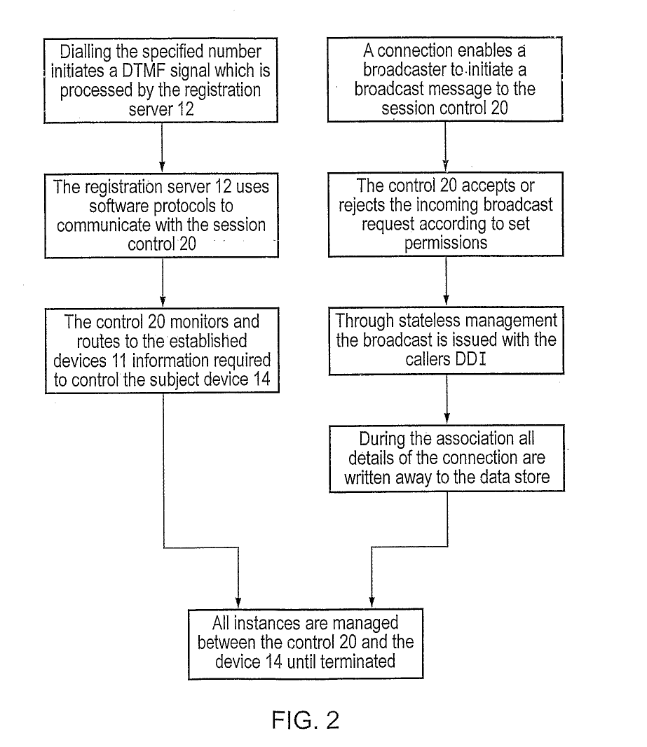

FIG. 2 in a block diagram of an example of a method or process in accordance with aspects of the present invention.

Aspects of the present invention integrate a remote communication device possibly acting as a handset within a stateless session communication process. In accordance with aspects of the present invention, once the communication device, which is typically a mobile phone or other mobile communication apparatus, makes contact with a system in terms of registration or sufficient to communicate a status, or change of status, event or action and establishing a handshake control interaction, an access server continues to provide an interface with a controlled subject device through the communication device. Instructions are received typically in a multi-frequency tone protocol, such as dual tone multi-frequency or touch tone switching as a signal language regime, whilst the access server converts as an interface such instructions into appropriate control commands to a subject device, through an applications link.

Control of the subject device is maintained until the communication with the system, by the communication device, is disconnected or terminated. This disconnection or termination may be by a positive action of a user or time dependent.

The system and method, in accordance with aspects of the present invention, may be utilised to provide an interface which can control a range of subject devices capable of receiving and responding to appropriate instructions and requests. Control is typically by digitised instructions from the applications link of the access server. Typically, the access server incorporates a store for access indicators to the subject devices. In such circumstances access to the store by the communication device is achieved through connecting through or via an interface, typically in the form of a registration server. Such an arrangement enables intelligent association between the communication device and the systems necessary in order to provide control functions to a subject device. Thus, systems and methods in accordance with aspects of the present invention, combine delivery of potentially high levels of control functions with simpler session generated allocated function control signals originating from the communication device. It will be appreciated that the control function may involve manipulation of a camera in terms of angle and orientation or focusing and, therefore, provide simple up, down, sideways or other iterative signals. Alternatively, the control function may relate to the request of data files necessary to present customer information or allow interaction with regard to gaming, or media or presentation of public information.

It is known to provide control regimes in which, for example with regard to an answer phone service, an individual can telephone from a remote location, whether than be with a mobile phone or from a phone in a public kiosk to the home answer phone and input a security code or similar access key to enable recovery of messages remotely. In such circumstances, the arrangement is dependent upon consistent capability with respect to the signal language regime and possibly the transmission quality between the remote communication device (mobile phones/public phone) and the subject device, that is to say the answer machine. In such circumstances, there are limitations to such systems, in particular with regard to the capability of active and responsive control. More recently, with greater availability in particular of communication devices such as mobile phones, it has become possible to track an individual in terms of their location and requirements. Thus, for example, a user may utilise their mobile phone in order to order tickets, firstly by identifying themselves through a personal PIN then identifying a particular ticket required then making payment. This will typically be a single stage relationship between the user and the service provider. The service provider, once approval has been achieved, will then transmit through an appropriate communication network, an instruction to the box office, or otherwise, to issue a ticket when the user presents some form of identity. This system can be expanded to situations where access to public displays etc can be achieved. For example, a mobile phone or an identicard incorporating an Radio Frequency Identification (RFI) device may be utilised in order to activate through an appropriate system, a display either specific for that individual or group of individuals or simply for more public information upon entering within proximity of a read location. However, such an approach allows limited active control by a user due to the potential wide range of actions required. Aspects of the present invention attempt to avoid such problems by establishing a consistent effective command set. Control functions have allocated function control signals as provided by the communication device. The control functions are consistent with potential responses by a subject device such as a visual display screen, alarm or camera and key function available from a handshake control interaction by the communication device using for example DTMF.

The enclosed drawing provides a schematic illustration of an access system for controlling subject devices in accordance with aspects of the present invention. The system 10 comprises a communication device 11 such as a mobile phone, a registration server 12, an access server 13 and subject devices 14. Communication between the access server 13 and subject devices 14, as well as typically the registration server 12 and the access server 13, will be through an internet connection utilising the World Wide Web. It will be appreciated that in some instances the registration server 12 and the access server 13 and its component parts may be integrated into one installation but more normally are dispersed to a number of sites or locations with appropriate communication paths as described above, particularly utilising the internet and other telecommunication networks.

Initially, a connection or status notification 16 is made between the communication device 11 and the registration server 12 by dial up. The registration server 12 can identify the communications device 11 in terms of an individual user or an identified usage requirement. As will be described later, the system, in accordance with aspects of the present invention, can be utilised for a wide number of control functions. In such circumstances these control functions may be defined by the identified user or an identified specific requirement from or to or for the user. It is not essential, at least at this stage, for the communication device 11 to provide a security access code or otherwise. The principal function of the communication or registration connection 16 is to establish an appropriate signal language regime to allow control functions as described later. The language regime will allow allocation of at least one allocated function control signal within an appropriate control handshake interaction with the registration server 12. This control interaction will take the form of a handshake control interaction or status notification with the communication device 11 so once registered it will be able to communicate allocated function control signals to the registration server 12 or once a link is established, as will be described later, alternate session control paths 17 to the access server 13.

Particular advantages in accordance with aspects of the present invention are achieved by establishing utilisation of dual tone multi-frequency signalling as the signal language regime between the communication device 11 and the server 12 or alternate session control path 17 in accordance with aspects of the present invention. Such a dual tone multi-frequency signal regime effectively provides distinct switch signals activated by keys 18 of the communication device 11. Each one of these distinct key switch signals can be an allocated function control signal, in accordance with aspects of the present invention, provided through the handshake interaction with the server 12 or path 17. The allocated function control signal, as indicated will provide a desired control function upon the subject device 14 as will be described later.

Upon initiation, possibly only registration by the communication device 11 is achieved for the required period. Nevertheless the registration server 12 will establish a register communication path 19 to the access server 13 and in particular a session control element 20 of the access server 13. The register communication path 19 communicates requests from the communication device 11 to the session control element 20. The session control element 20 in accordance with aspects of the present invention acts to provide access routes as well as monitor requested control functions in terms of allocated function control keys. Upon initiation, as indicated above, the registration server 12 may request the session control element 20 to establish an application link 21 to an application control element 22 of the server 13. The application control element 22 is in communication with the subject devices 14. Alternatively, registration will simply show availability for connection to and for applications when suitable subject devices are offered or available.

The session control element 20 has access to a data store memory 23, whereby necessary application links 21 can be identified and established through the application control element 22 to the respective subject devices 14. There may be a number of application control elements 22 with in such circumstances a respective first application link 21 from the session control element 20 to a respective application control element 22 for subsequent application links 21a, 21b, 21c to respective subject devices 14a, 14b, 14c. The data store 23 provides information with regard to the necessary links to establish the application links for respective devices 14 in use.

It will be appreciated that a subject device 14 can either operate in a continuous or reactive mode. In a continuous mode generally a constant application link 21 is established between the subject devices 14 and the application control element 22 or at least periodic establishment of links 21 occurs, that is to say every few second or some other time period. Alternatively, in a reactive mode, the application control element 22 will specifically provide application links 21, when required to the subject devices 14. In either event, communication between the application control element 22 and the devices 14 will be via appropriate internet signal language protocols. Again, continuous, intermittent or reactive application links 21 can be established between the applications control element 22 and the session control element 20. It will be appreciated that continuous provision of application links 21 through the applications control element 22 will be advantageous in terms of ensuring a rapid response, but may be disadvantageous with respect of equipment utilisation and use of band width.

The data store 23 provides a principal means by which determinations are made as to the requirements of the communications device 11, registered through the registration server 12. It will be appreciated that the communication device 11 can be utilised in a number of ways. Thus, the communication device 11 may have an in-built identifier such as a phone number, which may enable the data store 23 to establish the identity of the owner of the communications device 11 and their previous history. Thus, the data store may be able to determine that the particular user is male or female, their home address and previous interactions with the access system in accordance with aspects of the present invention. In such circumstances, the data store 23 or the session control element 20 can then establish appropriate application links 21. Thus, for example, the data store 23 may store a list of session information that can be related to products through the application link where this is a data request. In such circumstances the communication device 11 and in particular the owner of that device may register an interest in certain products through the access system in accordance with aspects of the present invention, such that when appropriate, this information will be retrieved using this relationship to enable the session control element to establish an application link 21 through the application control element 22 to a subject device 14a which is a visual display screen in a shopping centre, such that when the communication device 11 comes within the vicinity of that subject device 14a an appropriate advert is displayed. Conversely, the subject device 14a may be loaded with a particular advert, which is then indicated through the application link 21 to the session control element 20, such that upon registration via the communication device 11 by communicating with the registration server 12 through the specific connection 16 established by the user of the communication device 11, and engaging the elements of the access server, the advert on the subject device 14a will appear. This advert may list a range of products and then through the dual tone multi-frequency signal language regime established between the communication device 11 and the registration server 12, interaction with the subject device 14 is achieved. Thus, with the visual display as described above, the advert may indicate there is a promotion with respect of a particular product and the communication device 11 may register an interest in that particular promotion. The promotion may relate to a discount provided for response within a certain period of time or an offer limited to a specific number of products, which the user of the communication device 11 must respond to before all of the promotion products have been disposed of. Alternatively the subject device as a screen may display an invitation to users or passers by to use their communication device 11 to obtain more information specific to their requirements.

The data store 23 may also provide historic information with regard to the communication device 11 in terms of previous operations and interactions and so adjust the offering in terms of subject devices to the communications device.

Once a path comprising connection 16, registration communication path 19 and an application path 21 is established by an initiating device, whether that be the communication device 11 or a subject device 14 generally it will be appreciated that some form of acknowledgement will be provided. Upon the communication device 11 this may be provision of an icon or other device in a display 24. With regard to the subject device 14 this may be activation of an LED or other action including simple movement of a camera or otherwise acknowledging connection. It will also be appreciated with regard to a mobile phone used as the communication device 11 a communication will be possible either via (SMS), MMS IVR or Bluetooth and may be sent by the access server 13 indicating a connection with or control of a particular subject device 14.

It will be appreciated that typically a communication device 11 will have access through the access server 13 to a large number of subject devices 14. Some devices 14 should be available whilst others should not. In such circumstances either the session control element 20 or the application control element 22 will typically incorporate some form of filter to control access by the communication device 11. It will be appreciated that the session control element 20 is arranged to monitor and establish the communication paths from the communication device 11 to the subject devices 14 and in such circumstances typically it will be the session control element 20 which will establish identity (user or requirement) and access. A number of approaches can be taken with regard to monitoring and establishing such control paths. For example, the data store 23 as indicated may utilise some form of identity determination by the registration server 12. This identity registration may be in terms of the communications device 11 itself, a PIN access code provided by a user of the device 11 or through establishing a geographical location for the communication device 11 or position of that communication device 11. In such circumstances where the communication device 11 itself provides an identity, it will be understood that that communication device, as a mobile phone, may be provided to, for example, a security guard, in order to provide access to a number of subject devices 14. Clearly where security controlled access is required again the data store will provide to the session control element 20, an appropriate list of available subject devices.

With respect to geographical location, the data store 23 may have a list of subject devices 14 within a geographical range of the communication device 11. In any event, the session controller 20 in such circumstances may offer a range of subject devices 14 to the communication device 11 to allow access and control in accordance with aspects of the present invention. Alternatively, the subject devices 14 in accordance with aspects of the present invention will allow communication through the application links 21 to the session control element 20. In such circumstances generally the subject devices 14 will have a fixed geographical location and when the communication device 11 moves within that geographical location and provided that the communication device 11 is authorised, access to that particular subject device may be offered to the communication device 11 through an appropriate message.

Once the session control element 20 has authenticated control of the subject device 14, that control is maintained using the communication device 11 to send commands converted by the effective interface between the registration server 12 and the access server 13 between the subject device 14 and the communication device 11. As indicated the communication device 11 will include at least one allocated function control signal for control functions at the subject device 14.

In accordance with aspects of the present invention, once the link between the communication device 11 and the subject device 14 is established it will be understood that this link may last for a fixed period of time or whilst an event occurs or until there is specific termination of the link either by the communication device 11 or the subject device 14. The session control element 20 may also monitor the link 21 between the communication device 11 and the subject device 14 so that if circumstances dictate that control of the subject device 14 is no longer available or if the communication device, for whatever reason is no longer active or within the geographical area or there are conflicting control functions provided with the subject device control will be terminated.

Generally, session information created by the access server will be saved to the data store 23 and either captured whilst the application session is in progress or as part of closure or may be available to query or allow billing at some later date. It will be appreciated that control of some subject devices 14 may be subject to a charge as will be described later.

FIG. 2 provides a block diagram illustrating the process or method in accordance with aspects of the present invention. Thus, as indicated above, generally there is a communication device path such that upon initial dialing by the communication device to a specified number, there is initiation of registration in terms of an appropriate signal language regime typically dual tone, multi-frequency signalling to the registration server 12. The registration server then communicates through appropriate software protocols to the session control 20, other monitors and routes to established devices 14, information required to control or achieve a reaction from the subject devices 14.

Once a communication device 11 is connected as indicated above, it is possible to enable activation of control of the subject device. Thus, for example, once a connection 16 is enabled, a subject device such as 14a as a public display screen may wish to initiate broadcast of a message or otherwise. Thus, a client subject device 14 initiates a broadcast message to the session control element 20 through the application link 21 and application control 22. The session control 20 either accepts or rejects the incoming broadcast dependent upon the set permissions. These set permissions typically will comprise effective statements by the communication device 11 and therefore issues as to the types of broadcast it would like to receive ie product promotions and/or information from the database 23 with respect to the preferences of the communication device 11. If the session controller 20 determines the broadcast is acceptable, then the broadcaster is issued with identity details, whether that be the specific identity of the callers through the communication device 11 or the communication devices preferences. In such circumstances the broadcast relationship which may be a product promotion or advertisement continues during the association of the connection between the communication device 11 and the subject device 14. The connection is monitored and stored in the data store, such that the broadcaster may be charged appropriately for the number of connections made. Generally, all instances of connections are managed by the control 20. Connection between the subject device and the communication device is maintained and managed until terminated. For example, the broadcaster may prompt the communications device to give a message to look at a screen to see the latest store offers or give advice etc. Using the records in the data store it will also be possible for the third parties to determine precise patterns in customer product and promotion choices which could be then combined with loyalty scheme intelligence to further enhance the relationship.

As indicated above, generally aspects of the present invention will utilise the established internet to provide communication paths. The communication devices 11 will typically comprise telephone device which may be fixed line or mobile and utilise established communication protocols including dual tone, multi-frequency and SMS messaging systems.

The subject devices may include security alarm systems, cameras, lights, visual display screens, locks, ticketing devices, media access terminals, media trial facilities, public information screens such as traffic indicator devices, toll and polling devices, tracking and other control/indicator devices such as in relation to heating control etc. Examples of the manner by which subject devices may be controlled in the accordance with aspects of the present invention include:

a) Control of a security system, camera or light when out of a users hand or distant from premises or requesting attention in a public place for example, to request to take control of a CCTV camera for personal security reasons such as when waiting for transport or withdrawing cash from a cash point machine.
b) Control, and or determine the status or location of a vehicle without reliance on physical presence or interaction with traditional controls.
c) Control of a television screen such as an extension of Pay per View services in a public area when out of home, for example it should be possible for a subscriber to still view programmes or channels for which they have paid a subscription when they are not in their own home, but are in a waiting room or remote establishment that is capable of receiving this service.
d) Control of music or media when in a retail store or a leisure establishment as a one time play or pre-purchase sample or “try before you buy” marketing process whereby the content could be played as an audio or combined audio and visual experience utilising a public facing store screen.
e) Control of a public information service facility whereby users of local authority services can request information or report issues by a menu displayed in a public facing screen provided in strategic areas for access by the community, for example in bus stations and close to shopping locations or within school grounds.
f) Control of a single contest or participation in a multi-contestant interactive game or quiz on a public facing screen.
g) Control of betting, enabling visitors at a licensed venue to place bets away from the traditional kiosk or tables by entering stakes and predicting outcomes of real or virtual events, for example to predict the correct match outcome from your seat within a stadium or other licensed premises via a public facing screen before and during the event.
h) Control and prioritizes the content of digital advertising by selecting items of interest to view and/or purchase when displayed on public facing screens in shopping centres, motorway service stations, travel homes, hotels and leisure facilities.
i) Control digital customer feedback mechanisms when persuaded to do so incentivised by promotions and special offers, for example to submit your favourite ride experience when leaving a theme park to win a free return ticket.
j) Control traffic and transport information display boards to determine schedule and ticket availability plus access advice on routes and detours.
k) Control vending machines to select media items that can be passed directly on to the device without physical handling.
l) Control electronic auction and bidding screens by submitting bids directly from the device and not limited to physical attendance.
m) Control homeshopping without dependence on traditional channel or internet methods.
n) Enable communication of the description, status or location of a machine, item or person

As indicated above aspects of the present invention particularly relate to systems and methods whereby active control of a subject device can be achieved through the interface of an access server establishing session pathways between the communication device and the subject device. This control may involve movement of the subject device or as indicated above stimulation of an information download. Control or activation will be as indicated through the provision of a handshake control instruction between the communication device and the registration server. This handshake control interaction will enable provision of control function signals which achieve the desired actions with regard to the subject device. In such circumstances a particular signal language regime is required such as DTMF or an alternative short range digital encryption or otherwise language utilised with dedicated key actions or allocated function control signals within the handshake control interaction.

In accordance with aspects of the present invention, the communication device as indicated provides a registration signal to the registration server 12 in order to establish a registration communication path to the access server 13. In such circumstances, by this approach, the identity of the communication device or its requirements is identified. The access server can then, through its respective session control element and applications control element, route and control paths and in particular a session control path and an application link to the subject device. The access server 13 acts as an interface to effectively translate the function signals from the communication device 11. As indicated these function signals may be provided through the connection 16 and registration server 12 or once a requirement is established an alternative path 17 created to the access server 13. In any event, within an environment in which different subject devices may operate with different signal protocols and regimes, the interface provided by the access server 13 translates the necessary requested commands from the communication device 11 into appropriate responses and movements by the subject devices 14. Thus as indicated with regard to a display as depicted with regard to subject 14a that display may be stimulated to initiate a download or display information such as an advertisement or information relevant to the particular communication device 11. It will be appreciated that the subject device may be a lock 14b. In such circumstances the communication device 11 may receive information with regard to lock status and be able to actuate locking or unlocking as required. Similarly with regard to a camera 14c this camera may be acquired and turned as appropriately by a user through the communication device 11 to be focused upon themselves or to watch their motor vehicle. Charging for such actions whether to the user of the mobile or communication device 11, or provision of the advertising through the subject device may be achieved through the collation of links and time of such links by the storage device 23 and subsequent billing.

In accordance with the above, it will be appreciated that the registration signal and/or the handshake control interaction and/or registration communication path and/or the sensor control path and/or the device control protocol for each subject device 14 may be consistent in terms of the signal language regime or respectively different. If the signal language regime is consistent, then clearly the interaction and interface translation required by the access server 13 will be less important but generally it will be understood that subject devices will not operate in accordance with telephony type protocols such as dual tone, multi-frequency signal language regimes. The access server 13 will be required to provide the translation necessary. In such circumstances, typically there will at least be a difference between the signal language regime utilised by a device control protocol for each subject device and the signal language regime utilised for the registration signal and the handshake control interaction between the communication device 11 and the server 12.

Generally, the communication device will include a display to indicate the available control functions and the necessary key to be or that have already been switched or pressed to provide the associated control function signal for a respective control function. The allocation of keys and symbols may be consistent for all devices or the device through time links described above indicate the keys and so control functions available.

Modifications and alterations to aspects of the present invention will be appreciated by those skilled in the art. As indicated generally the communication paths provided, in accordance with aspects of the present invention, will utilise Internet web communications and other telecommunication techniques. In such circumstances, the session control element will also determine generally the appropriate pathways to achieve links between the subject devices and the communication device. These links will be monitored and assessed for security as well as reliability in operation. Generally, the applications link through the applications control element may establish default conditions for the subject devices. Thus, with respect to a lock a default position may be closed.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. An access system for device control, the system comprising a communication device, a registration server, an access server, a data store, and a subject device, the communication device arranged to provide a registration signal to define identity, upon registration of which the registration server is arranged to establish a communication path with the access server, the access server being operable to provide a session control path between the communication device and the subject device, wherein the access server is further operable to allocate a control function of the subject device to a function control signal of the communication device, such that a function control signal from the communication device received at the subject device via the session control path is operable to cause the subject device to perform the control function, and wherein a record of each function is associated with the identity and stored in the data store.

2. A system as claimed in claim 1 comprising a plurality of subject devices, wherein the access server is arrange to establish the session control path after analyzing the registration signal to determine whether an access indicator is present, the access indicator being associated with an application link to a subject device.

3. A system as claimed in claim 1 wherein the mobile communication device is a mobile communication apparatus.

4. A system as claimed in claim 3 wherein the mobile communication apparatus is a mobile phone, custom device or embedded controller which has connectivity to a voice network either via physical copper wire connection, cellular network or satellite.

5. A system as claimed in claim 1 wherein the subject device comprises a security alarm or camera, or light, or vehicle control.

6. A system as claimed in claim 5 wherein the multi-frequency tone signal language regime is dual tone, multi-frequency (DTMF) signal language.

7. A system as claimed in claim 6 wherein each dual tone signal comprises an allocated function control signal.

8. A system as claimed in claim 6 wherein each dual tone signal is accessed by a key on the communication device.

9. A system as claimed in claim 1 wherein at least the handshake control interaction is a short range digital encryption signal language.

10. A system as claimed in claim 9 wherein the short range digital encryption language is Blue Tooth with a respective encrypted identifier as the allocated function control signal for a respective control function for the subject device.

11. A system as claimed in claim 1 wherein the communication device incorporates a display.

12. A system as claimed in claim 1 wherein the communication device receives a response from the subject device indicative of status.

13. A system as claimed in claim 11 and any claim dependent thereon wherein the communication device, through the display, provides an indication for necessary actions to affect the allocated function control signal.

14. A system as claimed in claim 13 wherein the indication comprises a visual symbol indicating which key upon the control device is required to provide the allocated function control signal.

15. A system as claimed in claim 1 wherein the access server has a store for a plurality of access indicators for respective subject devices in a plurality of subject devices.

16. A system as claimed in claim 1 wherein the access server includes a user registration list, comprising previously controlled subject devices controlled by the communication device.

17. A system as claimed in claim 1 wherein the access server offers the user registration list to the communication device when the registration server receives the registration signal and provides the user registration list as a signal to the communication device.

18. A system as claimed in claim 1 wherein the registration signal includes a geographic identity signal such as but not limited to global positioning system (GPS), location based services (LBS) or satellite radio navigation (Galileo) if needed to determine proximity of accessible subject devices.

19. A system as claimed in claim 18 wherein the registration signal allows the geographic identity signal to be generated.

20. A system as claimed in claim 18 wherein the geographic identity signal is provided to the access server and the access server has a geographic subject device list, the access server can compare the geographic identity signal with the geographic subject device list and provide the geographic subject device list associated with the geographic identifier signal to the communication device.

21. A system as claimed in claim 1 wherein the geographic identity signal is provided to the access server and the access server has a geographic subject device list, the access server can compare the geographic identity signal with the geographic subject device list and provide the geographic subject device list associated with the geographic identifier signal to the communication device.

22. A system as claimed in claim 1 wherein the registration signal and/or the handshake control interaction and/or the register communication path and/or the session control path and/or the device control protocol utilize the World Wide Web.

23. (canceled)

24. A method for controlling a subject device using a communication device, the method comprising providing a registration signal to a registration server, establishing a communication path with an access server, establishing a session control path between the communications device and the subject device, allocating a control function of the subject device to a function control signal of the communication device such that a function control signal from the communications device received at the subject device via the session control path is operable to cause the subject device to perform the control function, and storing a record of each function selected by the communications device in a data store.

25. A method as claimed in claim 23 wherein the mobile communication apparatus is a mobile phone, custom device or embedded controller which has connectivity to a voice network either via physical copper wire connection, cellular network or satellite.

26. A method as claimed in claim 23 wherein the subject device comprises a security alarm or camera or light or vehicle control such as an immobiliser or television or visual display or audio distribution device or public information display or lock or access control module to services or goods.

27. A method as claimed in claim 23 wherein at least the handshake control interaction is a multi-frequency tone signal language regime.

28. A method as claimed in claim 27 wherein the multi-frequency tone signal language regime is dual tone, multi-frequency (DTMF) signal language.

29. A method as claimed in claim 28 wherein each dual tone signal comprises an allocated function control signal.

30. A method as claimed in claim 28 wherein each dual tone signal is accessed by a key on the communication device.

31. A method as claimed in claim 23 wherein at least the handshake control interaction is a short range digital encryption signal language.

32. A method as claimed in claim 31 wherein the short range digital encryption language is Blue Tooth with a respective encrypted identifier as the allocated function control signal for a respective control function for the subject device.

33. A method as claimed in claim 23 wherein the communication device incorporates a display.

34. A method as claimed in claim 23 wherein the communication device receives a response from the subject device indicative of status.

35. A method as claimed in claim 33 and any claim dependent thereon wherein the communication device, through the display, provides an indication for necessary actions to affect the allocated function control signal.

36. A method as claimed in claim 35 wherein the indication comprises a visual symbol indicating which key upon the control device is required to provide the allocated function control signal.

37. A method as claimed in claim 23 wherein the access server has a store for a plurality of access indicators for respective subject devices in a plurality of subject devices.

38. A method as claimed in claim 23 wherein the access server includes a user registration list, comprising previously controlled subject devices controlled by the communication device.

39. A method as claimed in claim 38 wherein the access server offers the user registration list to the communication device when the registration server receives the registration signal and provides the user registration list as a signal to the communication device.

40. A method as claimed in claim 23 wherein the registration signal includes a geographic identity signal such as but not limited to global positioning system (GPS), location based services (LBS) or satellite radio navigation (Galileo) if needed to determine proximity of accessible subject devices.

41. A method as claimed in claims 40 wherein the registration signal allows the geographic identity signal to be generated.

42. A method as claimed in claim 40 wherein the geographic identity signal is provided to the access server and the access server has a geographic subject device list, the access server can compare the geographic identity signal with the geographic subject device list and provide the geographic subject device list associated with the geographic identifier signal to the communication device.

43. A method as claimed in claim 23 wherein the registration signal and/or the handshake control interaction and/or the register communication path and/or the session control path and/or the device control protocol utilise the World Wide Web.

44. (canceled)

45. An electronic device operated in accordance with a method as claimed in claim 23.

46. A computer disc incorporating a method as claimed in claim 23.
